(19) United States
(12) Patent Application Publication
(10) Pub. No.: US 2006/0199027 A1
(43) Pub. Date: Sep. 7, 2006

(54) Radiation curable adhesive composition

(76) Inventors: Wojciech Wilczak, Jersey City, NJ (US); Mikhail Laksin, Boonton, NJ (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 11/071,693

(22) Filed: Mar. 3, 2005

(51) Int. Cl. B32B 33/00

(52) U.S. Cl. 428/479.6; 156/325; 428/411.1

(57) ABSTRACT

A radiation curable composition containing one or more polar, ethylenically unsaturated monomers containing a carboxylic acid functionality and one or more non-polar, ethylenically unsaturated monomers containing a fatty acid ester or a fatty alcohol ether. A laminate label and methods of laminating a label and affixing the laminate label to a surface entail application of the radiation curable composition.

### BACKGROUND OF THE INVENTION

1. Field of the Invention

The present invention relates to a radiation curable adhesive composition for bonding to plastics.

2. Description of the Related Art

Adhesives have many uses such as adhesion of substrates which require sufficient bond strength. For example, adhesives can be used on polyolefins and plastics, which is often difficult to achieve due to non-polar film surfaces, waxy plasticizers present in the films, and other, not always well-understood reasons.

For example, adhesion of labels onto plastics are commonly used on food, beverage and pharmaceutical containers comprised of an outer clear protective plastic film bound to a face stock using a pressure sensitive laminating adhesive. While a plethora of adhesives have been developed for use with laminate labels, none have achieved universal application and proper adhesive strength.

One recently developed adhesion methodology involves the use of radiation curable adhesives, examples of which are disclosed in U.S. Pat. No. 6,472,056, issued to Rea, et al, which discloses a radiation curable adhesive composition containing at least 50% of a carboxylic acid functional monomer.

While radiation curable adhesive composition containing a carboxylic acid substituted monomer are known, issues with adhesive strength still exist. Therefore, a need exists for an adhesive suitable for applications involving polyolefins and other plastics that exhibit superior bonding strength. Further, there exists a need for an adhesive having superior water resistance.

### SUMMARY OF THE INVENTION

The present invention is a radiation curable adhesive composition containing one or more polar, ethylenically unsaturated monomers containing a carboxylic acid functionality and one or more non-polar, ethylenically unsaturated monomers containing a fatty acid ester having an aliphatic hydrocarbon component or fatty alcohol ether having an aliphatic hydrocarbon component.

The present invention also encompasses a method of laminating a label with the disclosed radiation curable adhesive composition, and a method of affixing a laminated label to a surface with the disclosed radiation curable adhesive composition. The present invention also includes a laminate label produced by the disclosed method.

### DETAILED DESCRIPTION

The present invention generally encompasses radiation curable adhesive compositions characterized by a combination of one or more polar, ethylenically unsaturated monomers and one or more non-polar, ethylenically unsaturated monomers. Specifically, the polar, ethylenically unsaturated monomers disclosed herein contain a carboxylic acid functionality and the non-polar, ethylenically unsaturated monomers contain a fatty acid ester or fatty alcohol ether.

The polar, ethylenically unsaturated monomer of the present invention may contain a polymerizable ethylenically unsaturated functionality (acrylate) and a polar (carboxylic acid) group linked by a group R. Importantly, herein, the term “acrylate” will designate all species being properly describable as either an acrylate (R₁═H), a methacrylate (R₁═CH₃), or a mixture thereof. In various embodiments, R represents a C₁-C₉ hydrocarbon chain. The hydrocarbon chain may optionally contain ether, ketone, ester, amine, amide and/or urethane linkages. The R group is generally a linear, branched, or cyclic hydrocarbon chain optionally containing oxygen or nitrogen substitution as mentioned, but may also incorporate heteroatom containing side chains, including but not limited to, amine or alcohol functionalities. Preferably, the carboxylic acid functionalized monomers of the present invention include compounds having acid numbers in the range of about 30 to 400, more preferably in the range of about 70 to 350, most preferably in the range of about 80 to 300. An acid number for the purpose of this application is defined as mg KOH/g.

Monomers may be formed from known chemical pathways, including but not limited to, the reaction of an ethylenically unsaturated compound containing a hydroxyl functional group with an anhydride. Examples of suitable hydroxyl compounds include, but are not limited to, 2-hydroxyethyl acrylate, 2-hydroxypropyl acrylate, 2-hydroxybutyl acrylate, 2-hydroxy 3-phenyloxypropyl acrylate, 1,4-butanediol monoacrylate, 4-hydroxycyclohexyl acrylate, 1,6-hexanediol monoacrylate, neopentylglycol monoacrylate, trimethylolpropane diacrylate, trimethylolethane diacrylate, pentaerythritol triacrylate, dipentaerythritol pentaacrylate, and hydroxy functional acrylates. Examples of hydroxy functional, radiation curable compounds having vinyl ether functional groups include, for example, 4-hydroxybutyl vinyl ether, and triethylene glycol monovinyl ether. The above listed compounds can be employed singularly or in a mixture of two or more thereof.

Examples of anhydrides suitable for reaction with the above listed hydroxyl compounds include, but are not limited to, phthalic anhydride, isophthalic anhydride, terephthalic anhydride, trimellitic anhydride, tetrahydrophthalic anhydride, hexahydrophthalic anhyride, tetrachlorophthalic anhydride, adipic anhydride, azelaic anhydride, sebacic anhydride, succinic anhydride, glutaric anhydride, maleic anhydride, malonic anhydride, pimelic anhydride, suberic anhydride, 2,2-dimethylsuccinic anhydride, 3,3-dimethylglutaric anhydride, 2,2-dimethylglutaric anhydride, dodecenylsuccinic anhydride, nadic methyl anhydride, and chlorendic anhydride. In one embodiment, the polar, ethylenically unsaturated monomer employed is the acrylate adduct prepared by the reaction of 2-hydroxyethyl acrylate and succinic anhydride, as shown below: 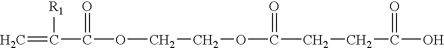
wherein R₁ is H.

Examples of suitable ethylenically unsaturated monomers not derived from the abovementioned reaction sequence include, but are not limited to, oligomeric forms of α,β-unsaturated acids, such as acrylic acid, which may be produced, for example, by a Michael addition reaction. In one embodiment, the dimer of acrylic acid (carboxyethyl acrylate) is employed as the polar, ethylenically unsaturated monomer.

The polymerizable species may contain any ethylenically unsaturated, radiation curable moiety. Examples of alternative ethylenically unsaturated species include, but are not limited to, styrenes, vinylethers, vinyl esters, N-substituted acrylamides, N-vinyl amides, maleate esters or fumarate esters.

In one embodiment, the polar, ethylenically unsaturated monomer employed is the acrylate adduct prepared by the reaction of 2-hydroxyethyl acrylate with succinic anhydride.

The polar, ethylenically unsaturated monomer may be present in the adhesive in an amount of between about 5 wt. % to about 95 wt. %, preferably between about 30 wt. % to about 70 wt. %

Suitable non-polar, ethylenically unsaturated monomer of the present invention include but are not limited to monomers containing a polymerizable ethylenically unsaturated functionality (acrylate) and a substituent R′. As above, the R₁ substitution may be either H or CH₃. The R′ group is a hydrocarbon unit containing at least one ether or ester linkage, and may also be substituted with one or more heteroatom groups, such as a hydroxyl. In addition, R′ contains one or more aliphatic hydrocarbon substituents having a total of between about 1 to about 9 or more carbon atoms, wherein at least one of the one or more ether or ester linkages is located between the ethylenic unsaturation and the one or more aliphatic hydrocarbon substituents.

The non-polar, ethylenically unsaturated monomers of the present invention may be formed from known chemical pathways, including but not limited to, the reaction of an ethylenically unsaturated compound containing a carboxylic acid group with an epoxide. Suitable examples of ethylenically unsaturated carboxylic acids include, but are not limited to, acrylic acid and (x-substituted acrylic acids, wherein the substituent is an alkyl, aryl, or cycloalkyl group having from about 5 to about 12 carbon atoms. In one embodiment, the non-polar, ethylenically unsaturated monomer is the reaction product of acrylic acid and Cardura™ Glycidyl Ester E10P (the glycidyl ester of Versatic™ Acid 10, both commercially available from Resolution Performance Products, LLC, of Houston, Tex.), wherein the Versatic Acid 10 is a fatty acid with 9 aliphatic carbon atoms.

Further, the ethylenically unsaturated monomer may be an acrylate, suitable monomers may contain any ethylenically unsaturated, radiation curable moiety. Examples of alternative ethylenically unsaturated species include, but are not limited to, styrenes, vinylethers, vinyl esters, N-substituted acrylamides, N-vinyl amides, maleate esters or fumarate esters. It is preferred that the non-polar, ethylenically unsaturated monomer is the acrylate adduct prepared by the reaction of acrylic acid with Cardura™ Glycidyl Ester E10P (the glycidyl ester of Versatic™ Acid 10, both commercially available from Resolution Performance Products, LLC, of Houston, Tex.).

The nonpolar, ethylenically unsaturated monomer may be present in the adhesive in an amount of between about 5 wt. % to about 95 wt. %, preferably between about 30 wt. % to about 70 wt. %

When the radiation curable adhesive is formulated for curing by exposure to visible light and/or ultraviolet light, one or more photoinitiators and/or photosensitizers can be used as polymerization initiators to reduce the cure time. Examples of suitable photoinitiators and photosensitizers include, but are not limited to, 2,2′-(2,5-thiophenediyl)bis(5-tert-butybenzoxazole), 1-hydroxycyclohexyl phenyl ketone, 2,2-dimethoxy-2-phenylacetophenone, xanthone, fluorenone, anthraquinone, 3-methylacetophenone, 4-chlorobenzophenone, 4,4′-dimethoxybenzophenone, 4,4′-diaminobenzophenone, Michler's ketone, benzophenone, benzoin propyl ether, benzoin ethyl ether, benzyl dimethyl ketal, 1-(4-isopropylphenyl)-2-hydroxy-2-methylpropane-1-one, 2-hydroxy-2-methyl-1-phenylpropane-1-one, methylbenzoyl formate thioxanthone, diethylthioxanthone, 2-isopropy!thioxanthone, 2-chlorothioxanthone, 2-methyl-1-(4-(methylthio)phenyl)-2-morpholinopropane-1-one, and 2,4,6-trimethylbenzoyldiphenylphosphine oxide. The one or more photoinitiators and/or photosensitizers can be incorporated in the radiation curable adhesive composition in an amount of between about 1 wt. % to about 15 wt. %, preferably between about 3 wt. % to about 10 wt. % by weight of the total composition.

If an electron beam is utilized to cure the adhesive composition via a free-radical process, a photoinitiator is generally not required. However, in cationically cured systems, use of a photoinitiator is advantageous even when employing an electron beam cure.

The adhesive compositions of the present invention optionally include additional components such as, but not limited to, fillers, flow additives, anti-foaming additives, pigments, dyes, and resinous materials dispersed or solubilized in the composition.

Radiation curable adhesive formulations according to the present invention contain a combination of the polar, ethylenically unsaturated monomer describe herein and the non-polar, ethylenically unsaturated monomer described herein, wherein the combined weight percent concentration of these two components is preferably greater than about 20%. The relative concentration of these two components is between about 1:19 and 19:1, polar monomer to non-polar monomer, preferably about 1:1.

Suitable substrates for adhesion include but are not limited to laminating polymer films include, but are not limited to, polyolefins such as low density polyethylene (LDPE) and oriented polypropylene (OPP), polyesters, polystyrenes, metallized substituents, nylons, and composites and copolymers thereof. Two substrates may be adhered together via the adhesive composition of the present invention.

Upon application of the adhesive composition, the surfaces may be brought into contact to effect bonding therebetween. The radiation curable adhesive composition can then be cured by well known methods, such as by UV light from medium pressure mercury lamps or low intensity fluorescent lamps or electron beam radiation.

### EXAMPLE 1

Nine laminating adhesives were compared and measured for bond strength by application applied to sheets of corona-treaded 1 mil LDPE (Pliant Corp) with a Meyer rod #3 to, and a second sheet of 1 mil LDPE was laminated using a hand roller. The adhesives were then cured under Electron Beam at 3 Mrads and 100 kV. The 1″-wide strips of the laminates were tested for bond strength in a T-peel mode using Instron 4441 tensile tester, at 2″/min peel speed. The results are set forth in the Table below:

| | A | B | C | D | E | F | G | H | I | J | K | L |
|---|---|---|---|---|---|---|---|---|---|---|---|---|
| H₂CCHC(O)OCH₂CH₂OC(O)CH₂CH₂C(O)OH | 100 | | 50 | | | | | | | | | |
| (adduct of succinic | | | | | | | | | | | | |
| anhydride and 2- | | | | | | | | | | | | |
| hydroxyethyl acrylate) | | | | | | | | | | | | |
| H₂CCHC(O)OCH₂CH(OH)CH₂OC(O)C₉H₁₉ | | 100 | 50 | | 50 | | 50 | | | | | 50 |
| (adduct of Cardura ™ E10P | | | | | | | | | | | | |
| and acrylic acid | | | | | | | | | | | | |
| H₂CCHC(O)OCH₂CH₂C(O)OH | | | | 100 | 50 | | | | | | | |
| (dimer of acrylic acid | | | | | | | | | | | | |
| (carboxyethyl acrylate) | | | | | | | | | | | | |
| H₂CCHC(O)OCH₂CH₂COC(O)o-C6H4C(O)OH | | | | | | 100 | 50 | | | | | |
| (adduct of phthalic | | | | | | | | | | | | |
| anhydride and 2- | | | | | | | | | | | | |
| hydroxyethyl acrylate) | | | | | | | | | | | | |
| H₂CCHC(O)OC(O)CH₂CH₂C(O)OH | | | | | | | | 100 | | 50 | | |
| (adduct of succinic | | | | | | | | | | | | |
| anhydride and acrylic acid) | | | | | | | | | | | | |
| H₂CCHC(O)O(CH₂)₁₃CH₃ | | | | | | | | | 100 | 50 | | |
| (myristyl acrylate) | | | | | | | | | | | | |
| Photomer ® 4846, (Cognis | | | | | | | | | | | 100 | 50 |
| Corp., Cincinnati, OH) | | | | | | | | | | | | |
| (Low acid value adhesion | | | | | | | | | | | | |
| promoter (acid number | | | | | | | | | | | | |
| <10)) | | | | | | | | | | | | |
| Average bond strength | 400 | 400 | 750 | 330 | 550 | 230 | 500 | 100 | 50 | 250 | 150 | 400 |
| (g/in) | | | | | | | | | | | | |

Adhesive A exhibited a “zippery” (stick-and-release) bond, Adhesives B and C exhibited a smooth bond. Unexpectedly and surprisingly, as demonstrated by Examples C, E, G, and L, the bond strength of the adhesive composition containing both a polar ethylenically unsaturated monomer and a non-polar, ethylenically unsaturated monomer of the present invention is significantly greater than the bond strength of compositions containing only a polar or non-polar ethylenically unsaturated monomer. Importantly, comparative example 1 illustrates that a non-polar, ethylenically unsaturated monomer which does not contain the fatty ester or fatty ether substituent does not produce a superior adhesive composition when combined with a polar, ethylenically unsaturated monomer. Comparative example 2 shows that even when a non-polar, ethylenically unsaturated monomer of the present invention is employed, the combination thereof with a polar, ethylenically unsaturated monomer containing a carboxylic functionality with a low acid number does produce the superior bond strength of the present invention.

In addition, the laminates produced according to the present method exhibit better water resistance than those produced with the adhesive compositions containing only a polar, ethylenically unsaturated monomer or a non-polar ethylenically unsaturated monomer.

While the foregoing is directed to embodiments of the present invention, other and further embodiments of the invention may be devised without departing from the basic scope thereof, and the scope thereof is determined by the claims that follow.

1. A radiation curable laminating adhesive composition comprising:
(a) one or more polar, ethylenically unsaturated monomers, wherein at least one of the polar, ethylenically unsaturated monomers comprises a carboxylic acid group having an acid number in the range of about 30 to about 400; and
(b) one or more non-polar, ethylenically unsaturated monomers, wherein at least one of the non-polar, ethylenically unsaturated monomers comprises a fatty acid ester containing a hydrocarbon substituent having about 5 to about 12 carbon atoms, or a fatty alcohol ether containing a hydrocarbon substituent having about 5 to about 12 carbon atoms.

2. The radiation curable laminating adhesive composition of claim 1, wherein at least one of the non-polar, ethylenically unsaturated monomers is a compound selected from the group consisting of:
an adduct of a fatty acid glycidyl ester and an acrylic acid,
an adduct of a fatty acid glycidyl ester and a methacrylic acid,
an adduct of a fatty acid glycidyl ester and an acrylic anhydride,
an adduct of a fatty acid glycidyl ester and a methacrylic anhydride,
an adduct of a fatty alcohol glycidyl ether and an acrylic acid,
an adduct of a fatty alcohol glycidyl ether and a methacrylic acid,
an adduct of a fatty alcohol glycidyl ether and an acrylic anhydride, and
an adduct of a fatty alcohol glycidyl ether and a methacrylic anhydride.

3. The radiation curable laminating adhesive composition of claim 1, wherein the one or more polar, ethylenically unsaturated monomers and the one or more non-polar, ethylenically unsaturated monomers together comprise at least 20 weight percent of the adhesive composition.

4. The radiation curable laminating adhesive composition of claim 1, wherein:
(a) at least one of the one or more polar, ethylenically unsaturated monomers is the adduct of 2-hydroxyethyl acrylate and succinic anhydride, and
(b) at least one of the one or more non-polar, ethylenically unsaturated monomers is the adduct of acrylic acid and Cardura™ Glycidyl Ester E10P (the glycidyl ester of Versatic™ Acid 10), wherein the Versatic Acid 10 is a fatty acid with 9 aliphatic carbon atoms.

5. A radiation curable laminating adhesive composition comprising:
(a) one or more polar, ethylenically unsaturated monomers, wherein at least one of the polar, ethylenically unsaturated monomers comprises a carboxylic acid group having an acid number in the range of about 30 to about 400; and
(b) one or more non-polar, ethylenically unsaturated monomers, wherein at least one of the non-polar, ethylenically unsaturated monomers comprises a fatty acid ester containing a hydrocarbon substituent having about 5 to about 12 carbon atoms, or a fatty alcohol ether containing a hydrocarbon substituent having about 5 to about 12 carbon atoms, wherein the relative concentrations of the one or more polar, ethylenically unsaturated monomers and the one or more non-polar, ethylenically unsaturated monomers is formulated to produce a bond strength of the adhesive composition as applied and cured that exceeds by 25% the bond strength of an adhesive composition wherein the polymerizable components therein consist only of the one or more polar, ethylenically unsaturated monomers or an adhesive composition wherein the polymerizable components therein consist only of the one or more non-polar, ethylenically unsaturated monomers.

6. The radiation curable laminating adhesive composition of claim 5, wherein at least one of the non-polar, ethylenically unsaturated monomers is a compound selected from the group consisting of:
an adduct of a fatty acid glycidyl ester and an acrylic acid,
an adduct of a fatty acid glycidyl ester and a methacrylic acid,
an adduct of a fatty acid glycidyl ester and an acrylic anhydride,
an adduct of a fatty acid glycidyl ester and a methacrylic anhydride,
an adduct of a fatty alcohol glycidyl ether and an acrylic acid,
an adduct of a fatty alcohol glycidyl ether and a methacrylic acid,
an adduct of a fatty alcohol glycidyl ether and an acrylic anhydride, and
an adduct of a fatty alcohol glycidyl ether and a methacrylic anhydride.

7. The radiation curable laminating adhesive composition of claim 5, wherein the one or more polar, ethylenically unsaturated monomers and the one or more non-polar, ethylenically unsaturated monomers together comprise at least 20 weight percent of the adhesive composition.

8. A method of laminating a label comprising:
(a) applying an adhesive composition to at least one surface of the label and/or at least one surface of a polymer film, wherein the adhesive composition comprises:
(i) one or more polar, ethylenically unsaturated monomers, wherein at least one of the polar, ethylenically unsaturated monomers comprises a carboxylic acid group having an acid number in the range of about 30 to about 400; and
(ii) one or more non-polar, ethylenically unsaturated monomers, wherein at least one of the non-polar, ethylenically unsaturated monomers comprises a fatty acid ester containing a hydrocarbon substituent having about 5 to about 12 carbon atoms, or a fatty alcohol ether containing a hydrocarbon substituent having about 5 to about 12 carbon atoms or more carbon atoms;
(b) contacting the label surface to be bonded with the polymer film surface to be bonded; and
(c) curing the adhesive composition with radiation.

9. The method of claim 8, wherein the polymer film comprises a material selected from the group consisting of:
polyolefins,
polyesters,
polystyrenes,
copolymers thereof, and
composites thereof.

10. The method of claim 8, wherein the label comprises a material selected from the group consisting of:
paper,
synthetic polymeric materials,
synthetic fibers,
plant fibers, and
combinations thereof.

11. The method of claim 8, wherein the radiation comprises an energy source selected from the group consisting of:
visible light,
ultraviolet light, and
electron beam.

12. A laminate label comprising a material containing at least one printed surface adhesively bonded to a polymer film, wherein the adhesion therebetween is effected by a process comprising:
(a) applying an adhesive composition to at least one surface of the label and/or at least one surface of a polymer film, wherein the adhesive composition comprises:
(i) one or more polar, ethylenically unsaturated monomers, wherein at least one of the polar, ethylenically unsaturated monomers comprises a carboxylic acid group having an acid number in the range of about 30 to about 400; and
(ii) one or more non-polar, ethylenically unsaturated monomers, wherein at least one of the non-polar, ethylenically unsaturated monomers comprises a fatty acid ester containing a hydrocarbon substituent having about 5 to about 12 carbon atoms, or a fatty alcohol ether containing a hydrocarbon substituent having about 5 to about 12 carbon atoms;
(b) contacting the surfaces to be bonded; and
(c) curing the adhesive composition with radiation.

13. A method of affixing a laminate label to a plastic surface comprising:
(a) adhesively bonding the laminate label to the plastic surface with an adhesive composition comprising:
(i) one or more polar, ethylenically unsaturated monomers, wherein at least one of the polar, ethylenically unsaturated monomers comprises a carboxylic acid group having an acid number in the range of about 30 to about 400; and
(ii) one or more non-polar, ethylenically unsaturated monomers, wherein at least one of the non-polar, ethylenically unsaturated monomers comprises a fatty acid ester containing a hydrocarbon substituent having about 5 to about 12 carbon atoms or more carbon atoms, or a fatty alcohol ether containing a hydrocarbon substituent having about 5 to about 12 carbon atoms;
(b) contacting the laminate label surface to be bonded with the plastic surface to be bonded; and
(c) curing the adhesive composition with radiation.

14. The method of claim 13, wherein the plastic surface comprises a material selected from the group consisting of:
polyolefins,
polyesters,
polystyrenes,
copolymers thereof, and
composites thereof.

15. The method of claim 13, wherein the label laminate comprises a material selected from the group consisting of:
polyolefins,
polyesters,
polystyrenes,
copolymers thereof, and
composites thereof.

16. The method of claim 13, wherein the radiation comprises an energy source selected from the group consisting of:
visible light,
ultraviolet light, and
electron beam.
